(19) United States
(12) Patent Application Publication
(10) Pub. No.: US 2010/0321801 A1
(43) Pub. Date: Dec. 23, 2010

(54) CEMENTED OPTICAL ELEMENT

(75) Inventors: Tomokazu TOKUNAGA, Hyogo (JP); Tetsuya SUZUKI, Osaka (JP); Toshiaki TAKANO, Osaka (JP)

Correspondence Address: HAMRE, SCHUMANN, MUELLER & LARSON P.C., P.O. BOX 2902, MINNEAPOLIS, MN, 55402-0902, US

(73) Assignee: PANASONIC CORPORATION, Osaka (JP)

(21) Appl. No.: 12/820,763

(22) Filed: Jun. 22, 2010

(30) Foreign Application Priority Data
Jun. 23, 2009 (JP) 2009-148598
Jun. 16, 2010 (JP) 2010-137159

(51) Int. Cl. G02B 11/00

(52) U.S. Cl. 359/796

(57) ABSTRACT

The present invention provides a cemented optical element including: a first optical element having a concave surface; a second optical element having a convex surface facing the concave surface; and an adhesive layer for bonding the convex surface to the concave surface. The concave surface and the convex surface are curved surfaces parallel to each other, with curvature centers thereof coinciding with each other on an optical axis. Thereby, the cemented optical element with high shape accuracy can be obtained.

### BACKGROUND OF THE INVENTION

1. Field of the Invention

The present invention relates to an optical element used in an imaging apparatus and an optical system of an optical pickup device. Particularly, the present invention relates to a cemented optical element in which optical elements with different shapes from each other are joined together.

2. Description of Related Art

Conventionally, a cemented optical element in which two or more kinds of optical elements or prisms are joined together has been produced by joining together optical elements, which have been finished in advance by grinding and press molding, with an adhesive typified by an ultraviolet curable resin. However, since the optical elements are deformed due to the shrinkage of the adhesive when the adhesive is cured, it has been difficult to maintain a desired accuracy.

In light of this, JP 2003-139914 A proposes to dispose a spacer at an outer periphery of a bonding face so as to control the thickness of an adhesive layer composed of an adhesive.

Generally, in a cemented optical element, optical elements are joined to each other at surfaces thereof having the same curvature radius. However, such a joining theoretically causes the adhesive layer to have a nonuniform thickness. Assume, for example, that a concave optical element having a spherical concave surface with a curvature radius of 10 mm is joined to a convex optical element having a spherical convex surface with a curvature radius of 10 mm in such a manner that a distance from the concave surface to the convex surface is 0.02 mm on an optical axis. In this case, the adhesive layer has a thickness of 0.02 mm at a center thereof, but the thickness is 0.014 mm at a position 4.5 mm away from the optical axis, reduced 20% from the thickness at the center.

Since the concave surface and the convex surface have the same curvature radius as each other, the adhesive layer has a nonuniform thickness as described above. Therefore, it is not possible to obtain a cemented optical element with desired accuracy even if a spacer is disposed at an outer periphery of a bonding face as in JP 2003-139914 A. This is because the adhesive shrinks differently at different positions when cured in production, thereby deforming the concave optical element and the convex optical element. Particularly, when a concave optical element whose central thickness is small is used, the deformation of the concave optical element becomes notable. Furthermore, during use, the amount of expansion or shrinkage because of a change in temperature is different at different positions in the adhesive layer. This also deforms the concave optical element and the convex optical element.

### SUMMARY OF THE INVENTION

The present invention has been accomplished in view of the foregoing. The present invention is intended to provide a cemented optical element with high shape accuracy.

In order to solve the aforementioned problems, the present invention provides a cemented optical element including: a first optical element having a concave surface; a second optical element having a convex surface facing the concave surface; and an adhesive layer for bonding the convex surface to the concave surface. The concave surface and the convex surface are curved surfaces parallel to each other, with curvature centers thereof coinciding with each other on an optical axis.

The present invention allows the adhesive layer to have a uniform thickness, making it possible to obtain a cemented optical element with high shape accuracy.

### BRIEF DESCRIPTION OF THE DRAWINGS

FIG. 1 is a cross-sectional view of a cemented optical element according to one embodiment of the present invention.

FIGS. 2A to 2C are halftone images of interference fringes observed on a cemented optical element according to an example or components thereof, each displayed on a display. FIG. 2A shows the shape accuracy of a first optical element alone. FIG. 2B shows the shape accuracy of a second optical element alone. FIG. 2C shows the shape accuracy of the cemented optical element.

FIG. 3 is a cross-sectional view of a cemented optical element according to a comparative example.

FIG. 4A to 4C are halftone images of interference fringes observed on the cemented optical element according to the comparative example or components thereof, each displayed on a display. FIG. 4A shows the shape accuracy of a first optical element alone. FIG. 4B shows the shape accuracy of a second optical element alone. FIG. 4C shows the shape accuracy of the cemented optical element.

### DETAILED DESCRIPTION OF THE INVENTION

Hereinbelow, embodiments of the present invention will be described in detail with reference to the drawings. In the embodiments, components having the same functions as each other are indicated with the same reference numerals and repetitive description thereof may be omitted.

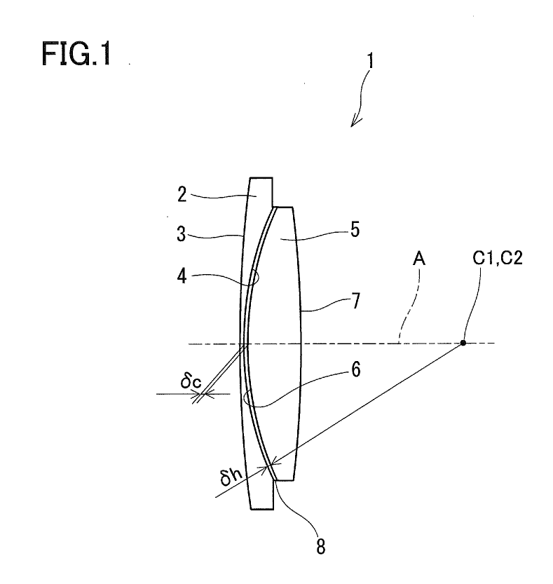

FIG. 1 is a cross-sectional view of a cemented optical element 1 according to one embodiment of the present invention. The cemented optical element 1 includes a first optical element 2, a second optical element 5, and an adhesive layer 8.

The first optical element 2 has a first surface 3 and a second surface 4 facing opposite to each other and intersecting with an optical axis A. The first surface 3 of the first optical element 2 is a convex surface, and the second surface 4 of the first optical element 2 is a concave surface. The first optical element 2 in the present embodiment is an example of an optical element having a concave surface.

The second optical element 5 has a first surface 6 and a second surface 7 facing opposite to each other and intersecting with the optical axis A. Both of the first surface 6 of the second optical element 5 and the second surface 7 of the second optical element 5 are convex surfaces. The second optical element 5 in the present embodiment is an example of an optical element having a convex surface.

The first optical element 2 is joined to the second optical element 5 by the adhesive layer 8. Specifically, the second surface 4 of the first optical element 2 is bonded to the first surface 6 of the second optical element 5 by the adhesive layer 8.

The adhesive layer 8 is composed of an adhesive that allows the first optical element 2 to be bonded to the second optical element 5. As the adhesive, an ultraviolet curable resin can be used, for example. The shrinkage of the ultraviolet curable resin in a curvature radius direction occurring when the resin is cured causes deformation of the first optical element 2 and the second optical element 5. Thus, it is desirable that the adhesive layer 8 have a uniform thickness in the curvature radius direction.

The second surface 4 of the first optical element 2 and the first surface 6 of the second optical element 2 are curved surfaces parallel to each other, with curvature centers C1 and C2 thereof coinciding with each other on the optical axis A. More specifically, a curvature radius of the second surface 4 of the first optical element 2 has a value larger than that of a curvature radius of the first surface 6 of the second optical element 5 by the thickness of the adhesive layer 8 in the same angular directions from the curvature centers C1 and C2. In other words, the curvature radius of the second surface 4 of the first optical element 2 has a value larger than that of the curvature radius of the first surface 6 of the second optical element 5, by the thickness of the adhesive layer 8 on the optical axis A.

The shape of the second surface 4 of the first optical element 2 and the shape of the first surface 6 of the second optical element are not particularly limited as long as the curvature centers C1 and C2 are on the optical axis A. Preferably, however, the second surface 4 of the first optical element 2 and the first surface 6 of the second optical element each have a line-symmetric shape with respect to the optical axis A on an arbitrary cross section including the optical axis A. For example, the second surface 4 of the first optical element 2 and the first surface 6 of the second optical element each may be a spherical surface with a constant curvature radius. Or they each may be an aspherical surface with a variable curvature radius, that is, an aspherical surface with the curvature center C1 or C2 moving on the optical axis A. Such an aspherical surface may be rotationally symmetric with respect to the optical axis A. Or it may not be rotationally symmetric with respect to the optical axis A (for example, it may be elliptical in shape when viewed from an optical axis direction.)

The thickness of the adhesive layer 8 refers to a thickness defined in a curvature center direction by the second surface 4 of the first optical element 2 and the first surface 6 of the second optical element 5. The thickness of the adhesive layer 8 is determined based on an optical design required for the finished cemented optical element. Thus, the curvature radius of the second surface 4 of the first optical element 2 and the curvature radius of the first surface 6 of the second optical element 5 can be determined according to the thickness of the adhesive layer 8.

Since the curvature radius of the second surface 4 of the first optical element 2 is set to be larger than the curvature radius of the first surface 6 of the second optical element 5 by the thickness of the adhesive layer 8 as described above, the curvature center C1 of the second surface 4 of the first optical element 2 falls on the same position as that of the curvature center C2 of the first surface 6 of the second optical element 5 when the first optical element 2 is bonded to the second optical element 5 in such a manner that the thickness of the adhesive layer 8 is 0.03 mm.

Accordingly, a gap between the first optical element 2 and the second optical element 5 has a uniform width, and thereby the thickness δc of the adhesive layer 8 on the optical axis A can be the same as the thickness δh of the adhesive layer 8 in the curvature center direction at an outer periphery.

In this description, the “curvature” refers to a numerically expressed value of a radius of a circle equivalent to a curved surface or a curved line at each point on the curved surface or the curved line. The “curvature center” refers to a center of this circle.

The thickness of the adhesive layer 8 in the curvature center direction can be uniform in the cemented optical element 1 according to the present embodiment because the curvature radius of the second surface 4 of the first optical element 2 has a value larger than that of the curvature radius of the first surface 6 of the second optical element 5 by the thickness of the adhesive layer 8 as described above.

Since the thickness of the adhesive layer 8 is uniform, the amount of the shrinkage of the adhesive occurring at the time of bonding is less likely to vary. Accordingly, it is possible to suppress the deformation of the first optical element 2 and the second optical element 5 caused by the shrinkage of the adhesive occurring when the adhesive is cured. Furthermore, the amount of expansion or shrinkage of the adhesive layer 8 occurring during use because of a change in temperature becomes uniform, and thereby the shape accuracy during use also can be maintained.

When the optical elements to be joined to each other have smaller thicknesses, they tend to be deformed easily due to the shrinkage of the adhesive. Therefore, the configuration according to the present embodiment particularly is effective when used for a cemented optical element including a concave meniscus lens whose thickness at a center is extremely small or a convex lens having an extremely thin edge.

For example, when a concave meniscus lens having a thickness of 0.3 mm or less on the optical axis (a central thickness of 0.3 mm) is used as the first optical element, it is preferable to employ the configuration according to the present embodiment because this concave meniscus lens is more likely to be affected by the shrinkage of the adhesive. Moreover, it is particularly preferable to employ the configuration according to the present embodiment when a concave meniscus lens having a thickness of 0.1 mm or less on the optical axis (a central thickness of 0.1 mm) is used as the first optical element because this concave meniscus lens is further likely to be affected by the shrinkage of the adhesive.

### EXAMPLES

Next, an example and a comparative example will be described. The present invention, however, is not limited to the following example at all.

### Example

The cemented optical element 1 according to the example will be described with reference to FIG. 1. Table 1 shows the design values of the cemented optical element 1 according to the example.

The cemented optical element 1 included the first optical element 2, the second optical element 5, and the adhesive layer 8 with a thickness of 0.03 mm.

The first optical element 2 was a concave meniscus lens with an outer diameter of 10 mm and a central thickness of 0.1 mm, having the first surface 3 with a curvature radius of 50 mm and the second surface 4 with a curvature radius of 10 mm.

The second optical element 5 was a convex lens with an outer diameter of 9 mm and a central thickness of 1.4 mm, having the first surface 6 with a curvature radius of 9.97 mm and the second surface 7 with a curvature radius of 36 mm.

The curvature radius (10 mm) of the second surface 4 of the first optical element 1 was set to a value larger than that of the first surface 6 of the second optical element 5 by the thickness (0.03 mm) of the adhesive layer 8.

TABLE 1

| | First optical | Adhesive | Second optical |
|---|---|---|---|
| | element | layer | element |
| Outer diameter | 10 | — | 9 |
| (mm) | | | |
| Central thickness | 0.1 | δc = 0.03 | 1.4 |
| (mm) | | (δh = 0.03) | |
| Curvature radius of | 50 | — | 9.97 |
| first surface (mm) | | | |
| Curvature radius of | 10 | — | 36 |
| second surface (mm) | | | |

As the adhesive composing the adhesive layer 8, Hardloc OP-1030M, an ultraviolet curable adhesive produced by DENKI KAGAKU KOGYO K.K., was used.

First, 0.002 cc of the adhesives was dropped on the second surface 4 of the first optical element 2. Subsequently, the second surface 4 of the first optical element 2 was attached to the first surface 6 of the second optical element 5 via the adhesive. Then, the adhesive was irradiated with ultraviolet rays. Thus, the cemented optical element 1 was obtained.

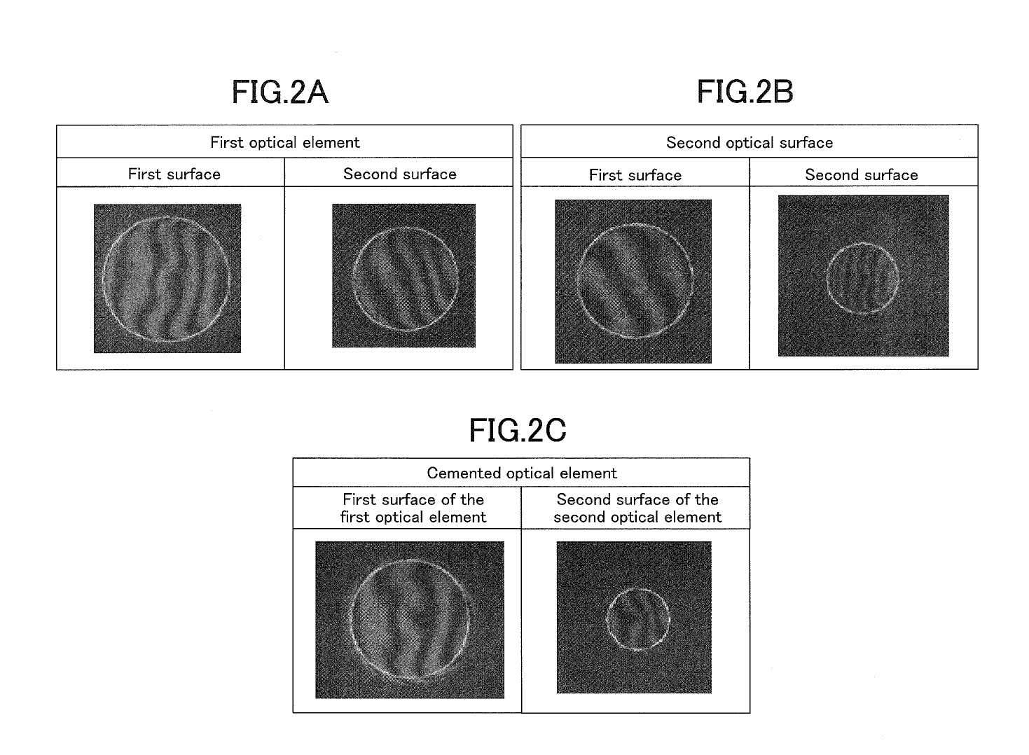

FIG. 2A shows halftone images of interference fringes indicating the shape accuracy of the first optical element 2 alone, displayed on a display. FIG. 2B shows halftone images of interference fringes indicating the shape accuracy of the second optical element 5 alone, displayed on a display. FIG. 2C shows halftone images of interference fringes indicating the shape accuracy of the cemented optical element 1, displayed on a display.

These shape accuracies were measured using F601, a laser interferometer manufactured by FUJINON.

The result shows that the cemented optical element 1 functions sufficiently enough as an optical element, although a slight transformation of shape due to the shrinkage of the adhesive appears compared to the first optical element 2 alone and the second optical element 5 alone.

From the result, it is understood that in the cemented optical element 1, the first optical element 2 was joined to the second optical element 5 without deteriorating significantly the shape accuracies of the first optical element 2 alone and the second optical element 5 alone.

In addition, a plurality of cemented optical elements that were the same as the cemented optical element 1 according to the present example were produced and evaluated for shape accuracy. They all showed satisfactory results. This indicates that it is possible to obtain stably the cemented optical elements with high accuracy.

The adhesive is not limited to the adhesive used in the present example. A silicone resin, etc. having excellent elasticity after being cured may be used.

### Comparative Example

Next, a comparative example will be described.

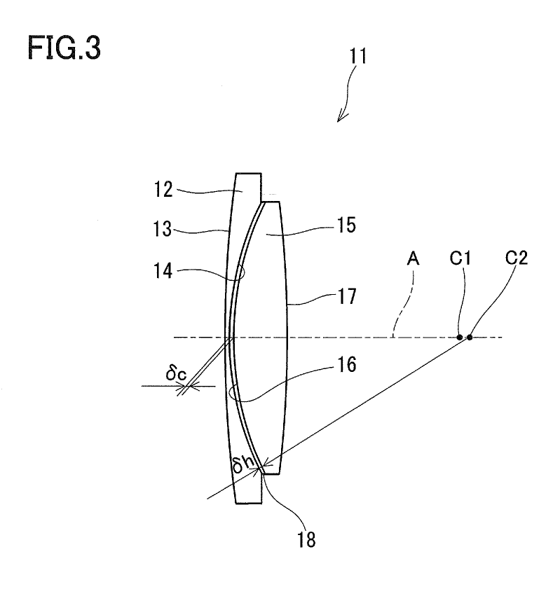

FIG. 3 is a cross-sectional view of a cemented optical element 11 according to the comparative example. Table 2 shows the design values of the cemented optical element 11 according to the comparative example.

The cemented optical element 11 had a first optical element 12, a second optical element 15, and an adhesive layer 18.

The first optical element 12 was a concave meniscus lens with an outer diameter of 10 mm and a central thickness of 0.1 mm, having a first surface 13 with a curvature radius of 50 mm and a second surface 14 with a curvature radius of 10 mm.

The second optical element 15 was a convex lens with an outer diameter of 9 mm and a central thickness of 1.4 mm, having a first surface 16 with a curvature radius of 10.00 mm and a second surface 17 with a curvature radius of 36 mm.

The cemented optical element 11 according to the comparative example is different from the cemented optical element 1 according to the example in that the second surface 14 of the first optical element 12 and the first surface 16 of the second optical element 15, which served as bonding faces, had the same value of curvature radius as each other.

Thus, the thickness of the adhesive layer 18 in the curvature radius direction was 0.03 mm at a center thereof, and 0.026 mm at an outer periphery thereof.

TABLE 2

| | First optical | Adhesive | Second optical |
|---|---|---|---|
| | element | layer | element |
| Outer diameter | 10 | — | 9 |
| (mm) | | | |
| Central thickness | 0.1 | δc = 0.03 | 1.4 |
| (mm) | | (δh = 0.026) | |
| Curvature radius of | 50 | — | 10 |
| first surface (mm) | | | |
| Curvature radius of | 10 | — | 36 |
| second surface (mm) | | | |

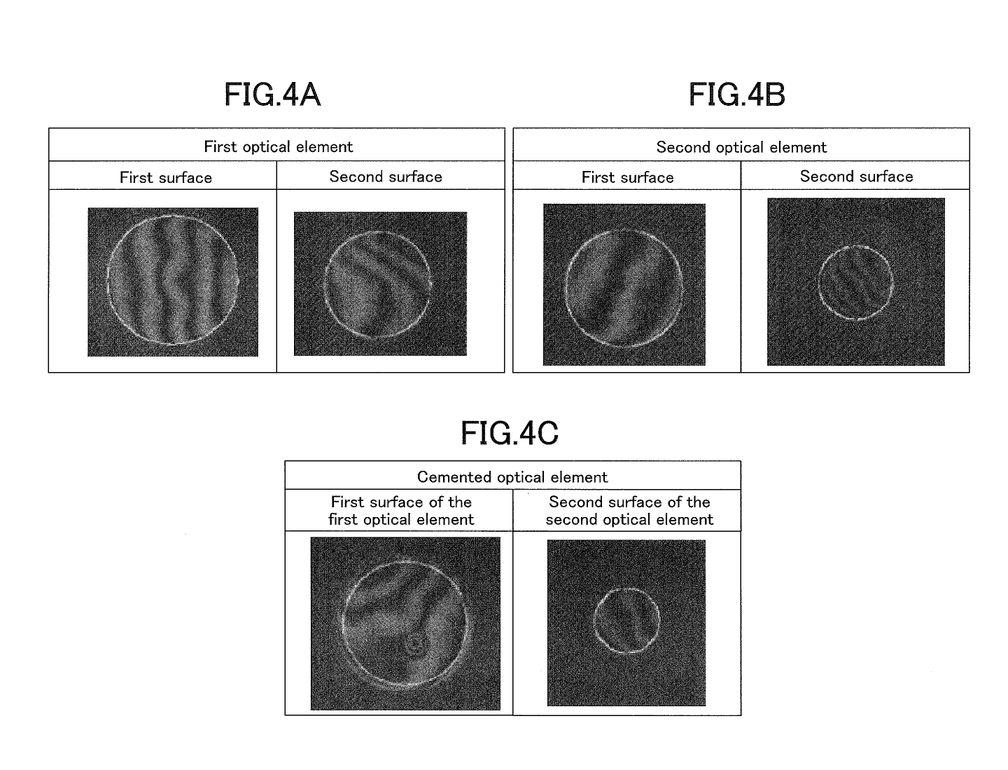

FIG. 4A shows halftone images of interference fringes indicating the shape accuracy of the first optical element 12 alone, displayed on a display. FIG. 4B shows halftone images of interference fringes indicating the shape accuracy of the second optical element 15 alone, displayed on a display. FIG. 4C shows halftone images of interference fringes indicating the shape accuracy of the cemented optical element 11, displayed on a display.

These shape accuracies were measured by the same method as in the example.

As shown in FIGS. 4A to 4C, the first optical element 12 alone and the second optical element 15 alone had no significant deterioration in shape. However, when they were joined to each other, the first optical element 12 particularly was deteriorated in shape.

Conceivably, this is because since the first optical element 12 had an extremely small central thickness of 0.1 mm, the first optical element 12 was more likely to be affected by the shrinkage of the adhesive and thus was deformed.

A plurality of cemented optical elements that were the same as the cemented optical element 11 according to the comparative example were produced and evaluated for shape accuracy. As a result, their shape accuracies varied significantly. This indicates that according to the comparative example, it is extremely difficult to obtain stably cemented optical elements with high accuracy.

The present invention is usable as an optical element used in an imaging apparatus and an optical system of an optical pickup device. Particularly, the present invention is usable as a cemented optical element in which optical elements with different shapes from each other are joined together.

The present invention is applicable to various other embodiments unless they depart from the intentions and the essential features of the invention. The embodiments disclosed in this description are to be considered in all respects as illustrative and not limiting. The scope of the invention is indicated by the appended claims rather than by the foregoing description, and all changes that come with the meaning and range of equivalency of the claims are intended to be embraced therein.

What is claimed is:

1. A cemented optical element comprising:
a first optical element having a concave surface;
a second optical element having a convex surface facing the concave surface; and
an adhesive layer for bonding the convex surface to the concave surface,
wherein the concave surface and the convex surface are curved surfaces parallel to each other, with curvature centers thereof coinciding with each other on an optical axis.

2. The cemented optical element according to claim 1, wherein a curvature radius of the concave surface is larger than a curvature radius of the convex surface by a thickness of the adhesive layer in the same angular directions from the curvature centers.

3. The cemented optical element according to claim 2, wherein the concave surface and the convex surface each are a spherical surface with a constant curvature radius.

4. The cemented optical element according to claim 1, wherein the first optical element is a concave meniscus lens having a thickness of 0.3 mm or less on the optical axis.

5. The cemented optical element according to claim 1, wherein the first optical element is a concave meniscus lens having a thickness of 0.1 mm or less on the optical axis.
